(19) United States
(12) Patent Application Publication
(10) Pub. No.: US 2011/0246770 A1
(43) Pub. Date: Oct. 6, 2011

(54) AUTHENTICATION METHOD, AUTHENTICATION SYSTEM, SERVER TERMINAL, CLIENT TERMINAL AND COMPUTER PROGRAMS THEREFOR

(75) Inventors: Mohamad Badra, Montrouge (FR); Ahmed Serhrouchni, Paris (FR); Thomas Guillet, Paris (FR)

(73) Assignees: CENTRE NATIONAL DE LA RECHERCHE SCIENTIFIQUE (C.N.R.S.), Paris (FR); UNIVERSITE BLAISE PASCAL, Clermont-Ferrand (FR); GROUPE DES ECLOES DES TELECOMMUNICATIONS, Paris (FR)

(21) Appl. No.: 12/922,496

(22) PCT Filed: Mar. 10, 2009
(86) PCT No.: PCT/FR2009/050385

§ 371 Date: May 23, 2011

(30) Foreign Application Priority Data
Mar. 14, 2008 (FR) 0851674

(51) Int. Cl. H04L 9/32

(52) U.S. Cl. 713/168

(57) ABSTRACT

An authentication method between a client (2) and a server (4) sharing a secret (6) includes the following steps:
the server (4) generates at least one random value (40);
the server (4) computes a first encrypted value (46);
the server (4) concatenates the random value (40) and the first encrypted value (46) to form a challenge (10);
the client (2) extracts the random value (40) and the first encrypted value (46) from the challenge (10);
the client (2) computes a second encrypted value (48);
the client (2) compares the first (46) and second (48) encrypted values; and
the server (4) is authenticated by the client (2) if the first (46) and second (48) encrypted values match.

The present invention concerns an authentication method between a client terminal and a server terminal connected to a data transmission network, said terminals sharing a secret and said method comprising the following steps:
the server terminal generates a challenge;
the challenge is sent from the server terminal to the client terminal over the network;
the client terminal computes a first response to the challenge, said computation comprising the application of a first function on a first set comprising the secret and the challenge;
the first response is sent from the client terminal to the server terminal over the network;
the server terminal computes a second response to the challenge by applying the first function on the first set comprising the secret and the challenge;
the server terminal compares the first and second responses; and
the client terminal is authenticated by the server terminal if the first and second responses match.

It also concerns an authentication system, a server terminal, a client terminal, and corresponding computer programs.

More specifically, the invention concerns the field of security in data networks and in particular authentication between two terminals connected to such a network.

Several security protocols were recently developed to make it possible to establish an authentication between connected terminals, to encrypt and protect the data exchanged between those terminals, and to monitor access to the network's resources and services.

Two authentication modes are currently used, i.e. one-way authentication and two-way authentication.

In one-way authentication, a single terminal is authenticated.

This mode is used in particular in first-generation networks generally based on client-server architectures, in which a client requests access to information provided by a server. The security protocols used in these networks are based, in the best cases, on a challenge/response-type process, in which the server sends the client a challenge and the client applies a cryptographic function to the challenge by using a shared secret (such as a password, for example). Thus, only the client is authenticated. This results in exposing it to several active and passive attacks, in particular the “man in the middle” attack.

The man in the middle attack is an attack in which a third party inserts itself into a communication between two terminals without the terminals' knowledge. This third party can then read, insert, and modify the encrypted messages between the two terminals as it wishes without anyone suspecting that the line between them has been compromised.

In the two-way authentication mode, each terminal authenticates the other terminal and vice versa.

Most security protocols propose one-way authentication and few use two-way authentication. As a non-limiting example, the SSL (“Secure Sockets Layer”) protocol supports both of the aforementioned authentication modes, while EAP-MD5 (“Extensible Authentication Protocol-Message Digest 5”), CHAP (“Challenge Handshake Authentication Protocol”), challenge/response mechanisms (used in particular with GSM (“Global System for Mobile communications”) networks, WLAN (“Wireless Local Area Network”) networks, Internet applications such as SIP (“Session Initiation Protocol”), WEB, email, etc., Digest Authentication and HTTP Digest only offer one-way authentication.

The difficulty in improving the authentication of the terminals in these networks and applications is that they are very widely deployed and used, such that changing their functionalities creates interoperability problems.

As a result, any proposed improvement must allow interoperability and compatibility with existing uses.

Recently, several two-way authentication methods were proposed making it possible to resolve the problems of one-way authentication, in particular the man in the middle attack.

As an example, the IETF (“Internet Engineering Task Force”) RFC (“Request for Comments”) 2759, proposed an extension of the CHAP protocol, called CHAP-v2 to provide two-way authentication.

Document EP1816616 also describes a method for establishing two-way authentication between two terminals by using random values and a shared key.

Moreover, in “Nouvelle méthode d′authentification EAP-EHash” [“New EAP-EHash Authentication Method”], CFIP Colloquium 2006 dated Oct. 30, 2006, Cheikhrouhou et al. propose a new two-way authentication method.

However, none of these methods allow interoperability and compatibility with widely deployed uses, in particular in mobile telephone and Internet networks.

The aim of the invention is to resolve these problems.

To that end, the invention concerns an authentication method between a client terminal and a server terminal connected to a data network, said terminals sharing a secret and said method comprising the following steps:
the server terminal generates a challenge;
the challenge is sent from the server terminal to the client terminal over the network;
the client terminal computes a first response to the challenge, said computation comprising the application of a first function on a first set comprising the secret and the challenge;
the first response is sent from the client terminal to the server terminal over the network;
the server terminal computes a second response to the challenge by applying the first function on the first set comprising the secret and the challenge;
the server terminal compares the first and second responses; and
the client terminal is authenticated by the server terminal if the first and second responses match,

characterized in that:
the step for generating the challenge by the server terminal comprises the following steps:
   the server terminal generates at least one random value;
   the server terminal computes a first encrypted value by applying a second function on a second set comprising the secret and the random value; and
   the server terminal concatenates the random value and the first encrypted value to form the challenge;

and in that the method comprises the following steps:
the client terminal extracts the random value and the first encrypted value from the challenge;
the client terminal computes a second encrypted value by applying the second function on the second set comprising the secret and the random value;
the client terminal compares the first and second encrypted values; and
the server terminal is authenticated by the client terminal if the first and second encrypted values match.

According to specific embodiments, the method comprises one or several of the following features, considered alone or according to all technically possible combinations:

the step for computation by the client terminal of a first response to the challenge comprises a step in which the client terminal concatenates the challenge and the result of the application of the first function on the first set comprising the secret and the challenge,

the first and second functions are chosen in a group of functions comprising:
a key derivation function KDF;
a pseudo-random function PRF;
an MD5 hash function;
a SHA hash function;
an authentication code procedure MAC;
an authentication code procedure HMAC;
a symmetric encryption algorithm of the RC4 or DES or 3DES or AES type; and
an authentication algorithm A3.

the first and second sets also comprise a plurality of known parameters of the client and server terminals,

the step for generation of the challenge by the server terminal comprises a step in which said server terminal concatenates the random value, the first encrypted value and the plurality of parameters,

the step for computation by the client terminal of a first response to the challenge comprises a step in which the client terminal concatenates the challenge, the result of the application of the first function on the first set comprising the secret and the challenge and the plurality of parameters,

the data network is an Internet network using a RADIUS infrastructure,

the information exchanged between the client and server terminals is encapsulated in EAP packets,

the EAP packets are exchanged between the client terminal and the server terminal via an access point,

the access point is a network administration server NAS.

the data transfer network is a GSM network.

the client terminal is a SIM card and the server terminal comprises a home location register HLR and an authentication center AuC.

The invention also concerns an authentication system comprising a client terminal and a server terminal connected to a data transmission network, said terminals sharing a secret and said system comprising:
means for generation of a challenge by the server terminal;
means for sending the challenge from the server terminal to the client terminal over the network;
means for computation by the client terminal of a first response to the challenge, said computing means comprising means for applying a first function on a first set comprising the secret and the challenge;
means for sending the first response from the client terminal to the server terminal over the network;
means for computation by the server terminal of a second response to the challenge comprising means for applying the first function on the first set comprising the secret and the challenge;
means for comparison by the server terminal of the first and second responses; and

means for authentication of the client terminal by the server terminal if the first and second responses match,

characterized in that:
the means for generation of the challenge by the server terminal comprises:
   means for generation by the server terminal of at least one random value;
   means for computation by the server terminal of a first encrypted value comprising means for applying a second function on a second set comprising the secret and the random value; and
   means for concatenation by the server terminal of the random value and of the encrypted value to form the challenge;

and in that the system comprises:
means for extraction by the client terminal of the random value and of the first encrypted value from the challenge;
means for computation by the client terminal of a second encrypted value comprising means for applying the second function on the second set comprising the secret and the random value;
means for comparison by the client terminal of the first and second encrypted values; and
means for authentication of the server terminal by the client terminal if the first and second encrypted values match.

The invention also concerns a server terminal connected to a data network, said server terminal sharing a secret with a client terminal connected to said network, and comprising:
means for generating a challenge;
means for sending the challenge to the client terminal over the network;
means for receiving a first response to the challenge from the client terminal;
means for computing a second response to the challenge comprising means for applying a first function on a first set comprising the secret and the challenge;
means for comparing the first and second responses; and
means for authenticating the client terminal if the first and second responses match;

characterized in that:
the means for generating the challenge comprises:
   means for generating at least one random value;
   means for computing a first encrypted value comprising means for applying a second function on a second set comprising the secret and the random value; and
   means for concatenation of the random value and the first encrypted value to form the challenge.

The invention also concerns a client terminal connected to a data transmission network, said client terminal sharing a secret with a server terminal connected to said network and comprising:
means for receiving a challenge from the server terminal;
means for computing a first response to the challenge, said computing means comprising means for applying a first function on a first set comprising the secret and the challenge;
means for sending the first response to the server terminal via the network,

characterized in that it comprises:
means for extracting a random value and a first encrypted value from the challenge;
means for computing a second encrypted value comprising means for applying a second function on a second set comprising the secret and the random value;
means for comparing the first and second encrypted values; and
means for authenticating the server terminal if the first and second encrypted values match.

The invention also concerns a computer program comprising code instructions, when the program is executed on a server terminal, allowing the implementation of the steps of the authentication method consisting of:
generating at least one random value;
computing a first encrypted value by applying a second function on a second set comprising a secret shared with a client terminal and the random value;
concatenating the random value and the first encrypted value to form a challenge;
sending the challenge to the client terminal;
receiving a first response to the challenge from client terminal;
computing a second response to the challenge by applying a first function on a first set comprising a secret shared with the client terminal and the challenge;
comparing the first and second responses;
authenticating the client terminal if the first and second responses match.

Lastly, the invention concerns a computer program comprising code instructions, which, when the program is executed on a client terminal, make it possible to carry out the steps of the authentication method consisting of:
receiving a challenge from a server terminal;
extracting a random value and a first encrypted value from the challenge;
computing a second encrypted value by applying a second function on a second set comprising a secret shared with the server terminal and the random value;
comparing the first and second encrypted values;
authenticating the server terminal if the first and second encrypted values match;
computing a first response to the challenge by applying a first function on a first set comprising the secret and the challenge; and
sending the first response to the server terminal.

Thus the invention makes it possible to offset the drawbacks of the one-way authentication methods widely used in modern networks and two-way authentication methods that are not compatible with the uses existing on those networks.

The solution proposed by the invention makes it possible to provide strengthened two-way authentication between two terminals that is completely compatible with the majority of the security protocols developed that use challenge/response-type processes.

We will now describe the embodiments of the invention more precisely, but non-limitingly, in light of the appended drawings, in which:

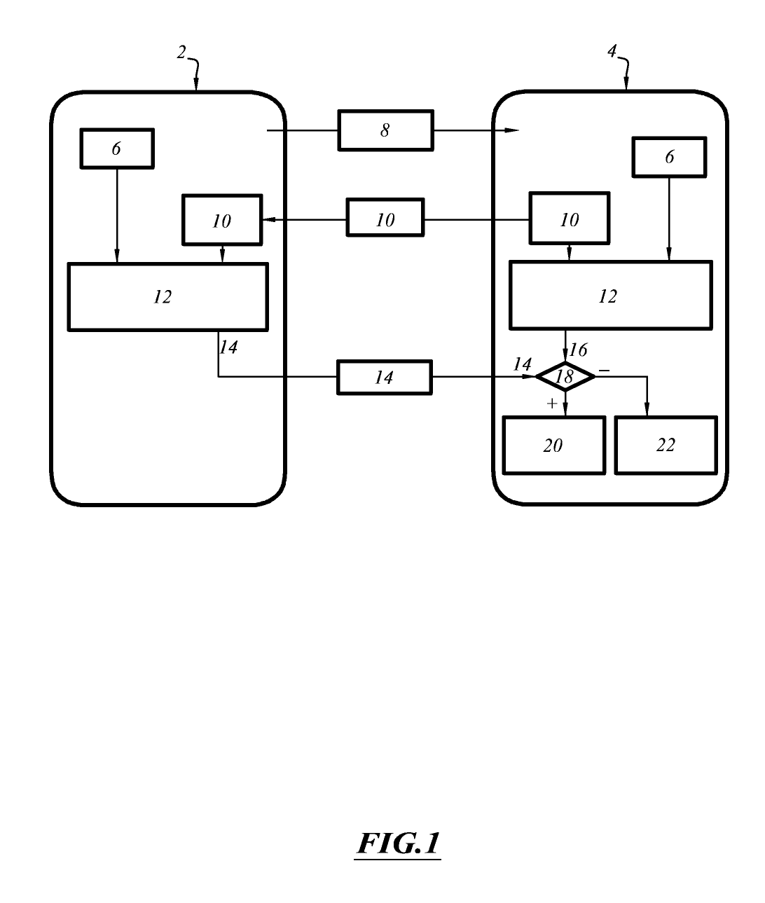

FIG. 1 is a synoptic diagram illustrating the structure and operation of a one-way authentication system of the prior art;

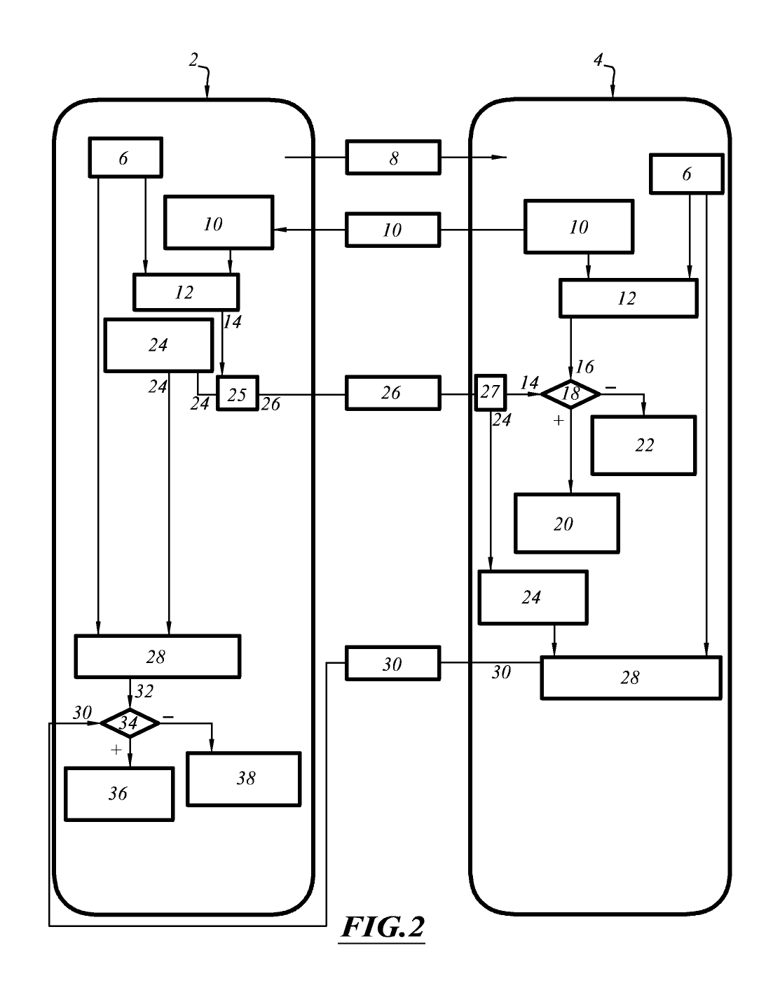

FIG. 2 is a synoptic diagram illustrating the structure and operation of a two-way authentication system of the prior art;

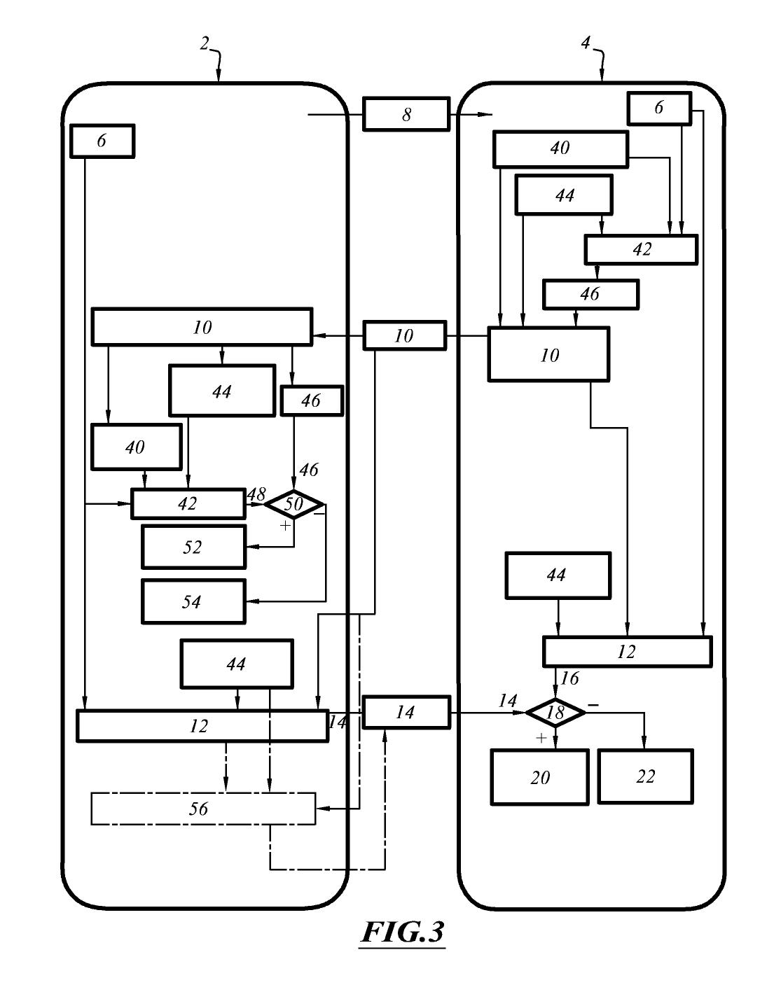

FIG. 3 is a synoptic diagram illustrating the structure and operation of the two-way authentication system according to the invention;

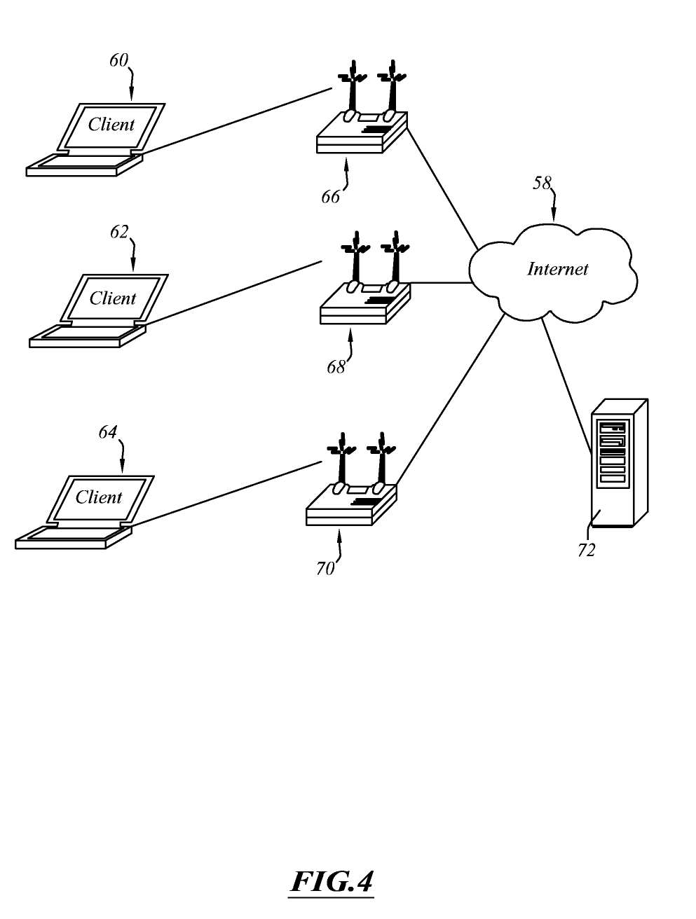

FIG. 4 is a synoptic diagram illustrating the structure of an authentication system according to a first embodiment of the invention;

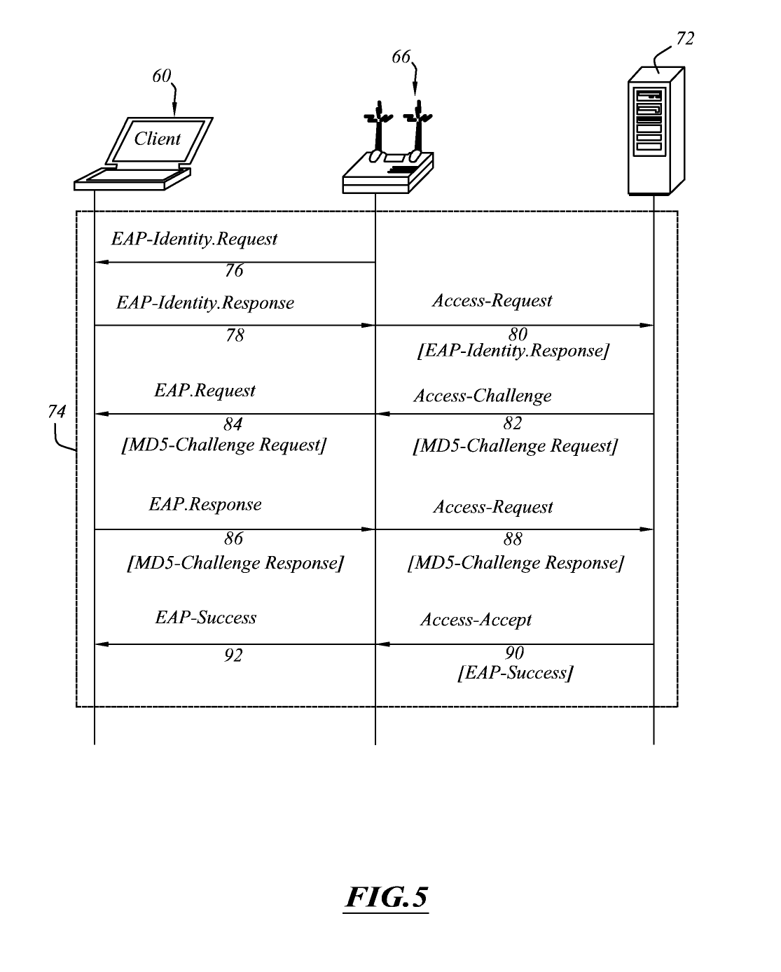

FIG. 5 is a synoptic diagram illustrating the operation of the authentication method according to the first embodiment of the invention;

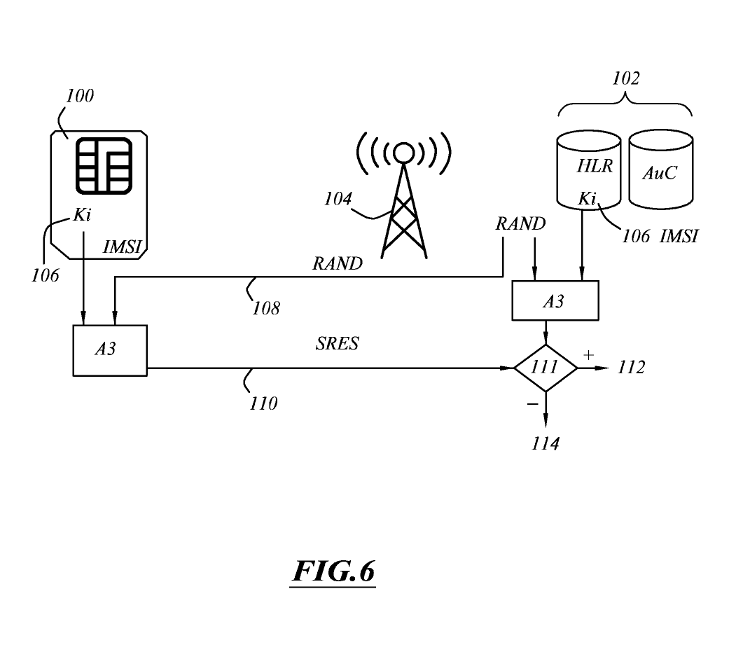

FIG. 6 is a synoptic diagram illustrating the structure and operation of the one-way authentication system of the prior art in a GSM network;

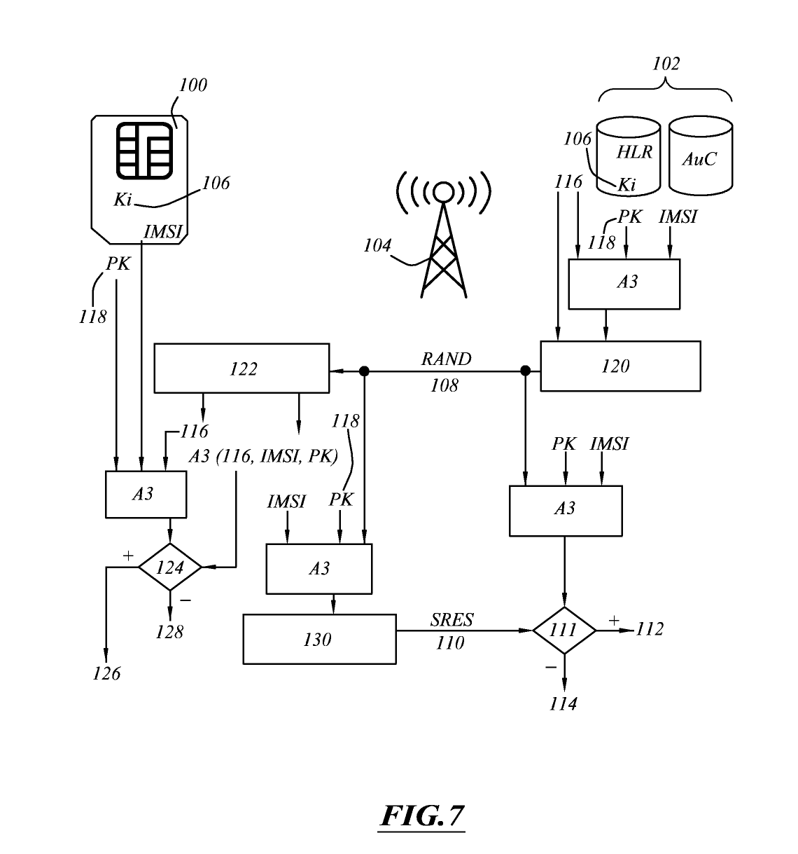

FIG. 7 is a synoptic diagram illustrating the structure and operation of the two-way authentication system according to the invention applied to a GSM network; and

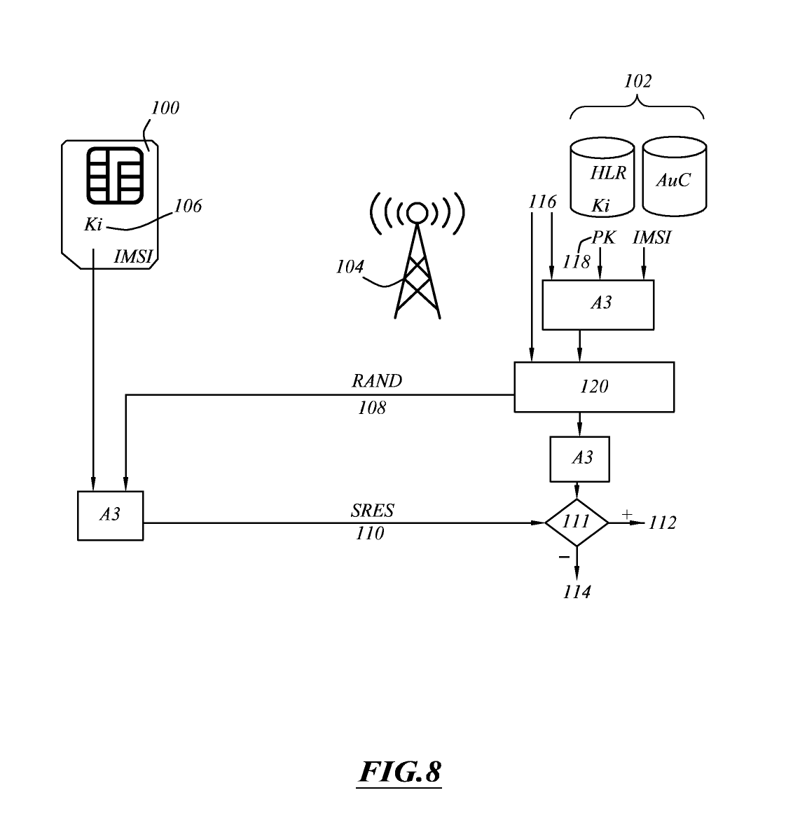

FIG. 8 is a synoptic diagram illustrating the compatibility of the authentication method according to the invention with the authentication method of the prior art in the GSM network.

FIG. 1 illustrates a generic case of one-way authentication between a client terminal 2 and a server terminal 4 connected to a data transmission network.

It should be noted that in the rest of the description, the terms “client” and “client terminal” as well as the terms “server” and “server terminal” mean the same thing.

The client terminal 2 and the server terminal 4 share a secret 6 identified by an identifier.

For example, the secret 6 describes a password or a shared key or a ticket, etc.

The client terminal 2 initializes the authentication session of the prior art by sending a connection request 8 to the server terminal 4 through the network.

The server terminal 4 responds to the request 8 by sending a challenge 10 that it has randomly generated beforehand to the client terminal 2 through the network.

The client terminal 2 applies a function 12 to the challenge 10 and the secret 6. The function 12 is, for example, a mathematical function or a cryptographic algorithm.

The client 2 obtains a response 14 after application of the function 12 on the challenge 10 and the secret 6 that it sends via the network to the server 4 to show that it indeed knows the shared secret 6.

For its part, the server 4 computes a response 16 to the challenge 10 by using the same function 12 applied to the shared secret 6 and the challenge 10.

The server 4 compares the response 14 sent by the client 2 and the response 16 it computed in 18.

If the responses 14 and 16 match, the server 4 authenticates the client 2 in 20.

If the responses 14 and 16 do not match, the server 4 does not authenticate the client 2 in 22.

This one-way authentication mode described in reference to FIG. 1 is used by several protocols standardized by the IETF committee, in particular CHAP and EAP-MD5.

Unfortunately, this method only makes it possible to authenticate the client 2, making it vulnerable to a large number of attacks, in particular the plaintext attack, the replay attack, the man-in-the-middle attack, the denial-of-service attack, the IP spoofing attack and the masquerade attack.

In order to resolve this vulnerability problem of the one-way authentication method, the IETF Committee extended some of the aforementioned protocols to provide two-way authentication. For example, the IETF RFC2759 proposes an extension of the CHAP protocol, named MS-CHAP-v2, to provide two-way authentication.

This extension is described in reference to FIG. 2. According to the two-way authentication method of prior art the MS-CHAP-v2, the server 4 authenticates the client 2 with which it shares the secret 6 in a manner similar to that of the method described in FIG. 1 by sending the randomly generated challenge 10 to the client 2. The client 2 applies the function 12 to the challenge 10 and to the secret 6 and obtains a response 14.

Moreover, according to the method described in FIG. 2, the client 2 randomly generates a second challenge 24 that it concatenates in 25 with the response 14, in a request 26 that it sends to the server 4. In 27, the server 4 extracts the response 14 from the client 2 to the challenge 10 and the second challenge 24 from the request 26.

The server 4 authenticates in 20, or does not authenticate in 22, the client 2 in the same manner as in the method according to FIG. 1 by comparing, in 18, the response 14 from the client 2 to the response 16 it computed itself.

The server 4 then applies a second function 28 to the second challenge 24 and to the secret 6. The second function 28 is, for example, a mathematical function or a cryptographic algorithm.

The server 4 obtains a response 30 following the application of the second function 28 on the second challenge 24 and the secret 6 it sends through the network to the client 2 to show that it indeed knows the shared secret.

For its part, the client 2 computes a response 32 to the second challenge 24 using the same second function 28 applied to the shared secret 6 and to the second challenge 24.

In 34, the client 2 compares the response 30 sent by the server 4 and the response 32 it computed.

If the responses 30 and 32 match, the client 2 authenticates the server 4 in 36.

If the responses 30 and 32 do not match, the client 2 does not authenticate the server 4 in 38.

The method described in FIG. 2 concerning the MS-CHAP-v2 extension indeed provides two-way authentication between the client 2 and the server 4. However, this method is not compatible with the one-way authentication method of the prior art described above in reference to FIG. 1.

Indeed, the MS-CHAP-v2 extension is a protocol in itself that does not ensure interoperability or compatibility with the one-way security protocols used in modern networks such as CHAP1 or HTTP Digest. This extension therefore cannot be used transparently with such protocols.

This compatibility and lack of interoperability are essentially due to the fact that the client 2 must have the ability to generate a challenge 24 different from that generated by the server 4 and to send it to the server 4 to be able to authenticate the latter, which means introducing a second challenge-response mechanism.

Thus the method of FIG. 2 is difficult to implement on existing client terminals, since they do not have that ability.

The invention makes it possible to resolve this problem by proposing an extension of the one-way authentication method of FIG. 1 allowing two-way authentication of the client and server terminals without adding new fields in these protocols as is the case with MS-CHAP-v2, which adds a second challenge/response mechanism.

The structure and operation of a two-way authentication system according to the invention are described in the continuation of the description in reference to FIGS. 3 to 8.

The method according to the invention thus allows mutual authentication between the client terminal 2 and the server terminal 4 connected to a data transmission network.

It should be noted that the term “terminal” has a very broad meaning in the context of the invention. Indeed, it can designate a computer or a mobile communication terminal such as a mobile telephone or a personal digital assistant, or even a computer device of the chip card or USB port or MMC card type.

The term “network” also has a very broad meaning in the context of the invention. It can designate a household network based on ADSL modems and Wi-Fi access points or a public network provided with base stations or wireless access points, or a business or government network using infrastructures of the LAN, PLAN, WLAN or MAN type.

As in the one-way authentication method according to the prior art described in reference to FIG. 1, the client 2 and the server 4 share the secret 6. The client 2 requests access to an application or service provided by the server 4 by sending the request 8.

Moreover, the authentication method according to the invention is also based on a challenge/response mechanism. However, contrary to the methods of the prior art described in reference to FIGS. 1 and 2, the challenge 10 is not a randomly generated value.

The invention in fact defines the semantics and structure of the challenge 10 owing to a new construction of the challenge 10.

According to this construction, as illustrated in FIG. 3, the server 4 generates a random value 40. It then applies a function 42 to the random value 40 to the secret 6 shared with the client 2 as well as to other parameters 44 detailed below to obtain a first encrypted value 46.

The function 42 is a mathematical function or a cryptographic algorithm that can designate a Key Derivation Function (KDF) or a Pseudo-Random Function (PRF) or an MD5 Hash Function (Message Digest) or an SHA hash function (Secure Hash Algorithm) or a Message Authentication Code (MAC) or Key-Hashing Message Authentication Code (HMAC) or a symmetric encryption algorithm of the RC4 or DES or 3DES or AES, etc. type or an authentication algorithm A3. The function 42 can also assume the form of a combination of two or several of the aforementioned forms.

The term “other parameters” 44 designates any type whatsoever of known parameters of the terminals 2 and 4. For instance, these other parameters 44 can designate sequence numbers, the current date and time of the system, random values, part of the headers and content of the messages exchanged between the terminals 2 and 4, the function 40 used, etc.

These other parameters 44 are optional. Indeed, according to one embodiment of the invention, the server 4 applies the function 42 only to the secret 6 and the random value 40.

However, it is preferable to incorporate the other parameters 44 into the computation of the first encrypted value 46 because their use makes it possible to strengthen the integrity of the messages exchanged between the client 2 and the server 4.

Once the server 4 has obtained the first encrypted value 46, it concatenates that value with the random value 40 and, according to one embodiment, with the other parameters 44 to form the challenge 10 it sends to the client 2.

Upon receiving the challenges 10, one of two cases arises:
the first case (not shown in FIG. 3) is the case according to which the client 2 does not support the extension defined by the present invention. In this case, the method continues as the one-way authentication method of FIG. 1, i.e. only the client terminal 2 is authenticated by the server terminal 4 according to the mechanism described in reference to FIG. 1. In this case, the server terminal 4 is not authenticated by the client terminal 2;
the second case (illustrated in FIG. 3) is the case according to which the client 2 supports the extension defined by the present invention. In this case, the client 2 extracts the random value 40, the other parameters 44 and the first encrypted value 46 from the challenge 10.

The client terminal 2 then applies the function 42 to the shared secret 6, the random value 40 and the other parameters 44 to obtain a second encrypted value 48.

In 50, the client terminal compares the first encrypted value 46 sent by the server 4 and the second encrypted value 48 that it computed itself.

If the two encrypted values 46 and 48 match, this proves that the server 4 indeed knows the secret 6. As a result, the client 2 authenticates the server 4 in 52.

If the two encrypted values 46 and 48 do not match, the client 2 does not authenticate the server 4 in 54.

The client 2 then computes the first response 14 to the challenge 10 generated by the server 4 by applying the function 12, cited in reference to FIGS. 1 and 2 of the prior art, to a set of values defined by the secret 6, the challenge 10 and the other parameters 44.

According to one embodiment of the invention (portion in broken lines in FIG. 3), the client 2 computes the first response 14 to the challenge 10 by concatenating the challenge 10 in 56, the result of the application of the function 12 to the set of values created and the other parameters 44.

The client 2 then sends the first response 14 to the server 4.

The server 4 then compares the first response 14 to the response 16 computed by it by applying the function 12 to the secret 6, the challenge 10 and the other parameters 44.

Lastly, in the same manner as in the methods of the prior art of FIGS. 1 and 2, if the responses 14 and 16 match, the client 2 is authenticated in 20; otherwise, the client 2 is not authenticated in 22.

The two-way authentication method according to the invention having been described in reference to FIG. 3, the rest of the description concerns two embodiments using this method in reference to FIGS. 4 to 8.

FIGS. 4 and 5 illustrate an embodiment in which the data transmission network is an Internet network using a RADIUS (“Remote Authentication Dial-In User Service”) infrastructure to perform the authentication and manage access to the network services. According to this embodiment, the data exchanged between the terminals connected to the network is encapsulated in EAP packets.

It should be noted in this respect that the IETF committee approved the EAP protocol (Extensible Authentication Protocol) to allow the transport of multiple authentication scenarios, some of which are defined by the EAP-TLS (“Transport Layer Security”, RFC 2246) and EAP-SIM (“Subscriber Identity Module>>, RFC 4186”) specifications.

The EAP entities authenticate each other using an EAP authentication method. This method is a layer above the EAP layer and it defines security and key distribution mechanisms. The authentication method traditionally used in this architecture is MD5-Challenge, described by standard IETF RFC 3748 and also known as EAP-MD5. This method as currently defined does not offer two-way authentication; only the client terminal wishing to connect to the network is authenticated.

One method for authenticating a RADIUS authentication server with an EAP client and vice versa is described in reference to FIGS. 4 and 5. This method makes it possible to manage several simultaneous sessions and use the structuring and semanticization mechanism of the challenge according to the invention in networks supporting a large population of users without decreasing performance.

In the RADIUS infrastructure of an Internet network 58 illustrated in FIG. 4, a plurality of clients 60, 62 and 64 are monitored by network administration servers (NAS) 66, 68 and 70 respectively located, for example, in access points of said network 58.

The NAS servers are connected, via the network 58, to a single authentication server 72 on which authentication software executed by a computer system provided with an operating system is installed.

Currently, a number of free software applications such as “OPEN RADIUS” or “FREE RADIUS” offer RADIUS authentication services.

Integrating the computer programs according to the invention in these software applications will make it possible to perform two-way authentication between the server 72 and each of the clients 60, 62 or 64.

FIG. 5 illustrates the exchange of information in the form of EAP packets between, for example, the client 60 and the RADIUS server 72 through the NAS server 66.

Thus, an authentication session 74 using the method according to the invention is illustrated in FIG. 5.

In 76, the NAS server 66 indicates the occurrence of the new authentication session 74 to the client 60 by producing an “EAP-Identity.Request” packet.

The client 60 inserts its identity in an “EAP-Identity.Response” packet in 78. In 80, the NAS server 66 sends this packet to the RADIUS server 72 in an “Access-Request” RADIUS packet.

The RADIUS server 72 generates, according to the method of the invention, described in reference to FIG. 3, a challenge 10 of the MD5 (MD5-Challenge Request” or “EAP-MD5 Request”) type and sends it in 82 to the NAS server in an “Access-Challenge” RADIUS packet. Upon receipt, the NAS server 66 sends the client 60 back the “MD5-Challenge Request” in a “EAP Request” packet in 84.

The client 60 recovers the type of EAP authentication method, i.e. “MD5-Challenge.” Next, the client 60 analyzes the MD5 challenge 10 according to the method of the invention to authenticate the RADIUS server 72. The client 60 constructs its response using the method according to the invention, then in 86 sends the response (“MD5-Challenge Response” or “EAP-MD5 Response”) to the NAS server 66 in an “EAP.Response” packet. The NAS server 66 encapsulates the response sent by the client 60 in an “Access-Request” RADIUS packet before sending it to the RADIUS server 72 in 88.

The RADIUS server 72 verifies the response from the client 60 according to the method of the invention. If that verification is successful, the RADIUS server 72 encapsulates the indication of the success of the client authentication 60 in an “Access-Accept” RADIUS packet and in 90 sends the packet to the NAS server 66. Upon receipt, the NAS server 66 encapsulates the indication of success of the authentication in an “EAP-Success” packet and sends it to the client 60 in 92.

Thus, the solution according to the invention makes it possible to transparently perform a two-way authentication between a client terminal and a server terminal connected to an Internet network using a RADIUS architecture.

In the continuation of the description, a use of an embodiment of the invention in a GSM network is described in reference to FIGS. 6 to 8.

According to one embodiment described in FIGS. 6 to 8, the client terminal is a SIM card 100 and the server terminal comprises a home location register (HLR) and an authentication center AuC whereof the unit is designated by HLR/AuC server 102. The exchanges between the SIM card 100 and the HLR/AuC server 102 are done through a base station 104.

FIG. 6 illustrates the one-way authentication method currently used in GSM networks.

This method is similar to that described in FIG. 1.

The SIM card 100 and the HLR/AuC server 102 share a key Ki 106.

During the authentication phase, the SIM card 100 sends its IMSI (International Mobile Subscriber Identity) identifier to the HLR/AuC server 102 via the base station 104. The HLR/AuC server 102 generates a random 128-bit number called RAND and sends it to the SIM card 100 in 108.

The SIM card 100 responds in 110 with a value called SRES generated by applying the algorithm A3 on the random number RAND and the shared key Ki 106.

The HLR/AuC server 102 performs the same computation and compares, in 111, the SRES value to the value of the result of its computation. If the two values match, the HLR/AuC server 102 authenticates the SIM card 100 in 112; otherwise, it does not authenticate it in 114.

FIGS. 7 and 8 illustrate the implementation of the method of the invention to extend the one-way authentication method in a GSM network described in reference to FIG. 6.

According to the embodiment of FIGS. 7 and 8, the HLR/AuC server 102 constructs the number RAND using the following steps:
generation of a random value 116;
application of the algorithm A3 to the set formed by the IMSI identifier of the SIM card 100, a private key PK 118 according to the shared key Ki 106, and the random value 116; and
formation of the RAND by concatenation in 120 of the random value 116 and the result of the application of the algorithm A3.

In order to ensure compatibility and interoperability with the method of FIG. 6, it is necessary for the number RAND to remain a random 128-bit number. Thus, according to one embodiment, the random value 116 is a 54-bit number.

The case according to which the SIM card implements the extension according to the invention is illustrated in FIG. 7.

In this case, upon receipt of the number RAND, in 122 the SIM card 100 extracts from this number the random value 116 and the result of the application of the algorithm A3 computed by the HLR/AuC server 102 that it compares in 124 to the result of the computation it did itself by applying the algorithm A3 to the private key PK 118, to the IMSI identifier, and to the random value 116. If the two results match, the HLR/AuC server 102 is authenticated in 126; otherwise it is not authenticated in 128.

Moreover, the SIM card 100 applies the algorithm A3 on the IMSI identifier, the private key PK 118 and the number RAND to obtain an encrypted value 130 that it sends in 110 in the SRES response to the HRL/AuC server 102.

The HLR/AuC server 102 performs the same computation and compares the two results to authenticate the SIM 100 card as described in FIG. 6.

The case according to which the SIM card 100 does not implement the extension according to the invention is described in reference to FIG. 8.

In this case, the SIM card 100 ignores the operations 122 to 130 and does not authenticate the HLR/AuC server 102.

Thus, the invention makes it possible to have a two-way authentication solution between the SIM card 100 and the HLR/AuC server 102 compatible and interoperable with the one-way authentication method currently used in GSM networks.

According to one embodiment of the invention, one manner of ensuring this interoperability of the invention with the authentication protocols of the prior art is to provide that the server 4 adds a characteristic to the challenge 10 indicating that it is a challenge structured in the manner provided in the invention.

If the client 2 implements the extension, it extracts that value from the challenge from which it previously removed the type of challenge characteristic and applies the steps of the method according to the invention described in reference to FIG. 3 (or FIG. 7 in the case of the GSM network).

If the client 2 does not implement the extension, it performs the steps of the authentication method of the prior art (FIGS. 1, 6 and 8) by applying the function 12 (or algorithm A3) to the challenge in its entirety, including the type-of-challenge characteristic.

A method according to the invention can therefore be used in any authentication system compatible with a server or client terminal in the form of corresponding computer programs including code instructions that, when said programs are executed, allow the steps of the method to be carried out.

Of course, other embodiments can also be considered.

1. An authentication method between a client terminal (2; 60; 100) and a server terminal (4; 72; 102) connected to a data transmission network (58), said terminals sharing a secret (6; 106; 118) and said method comprising the following steps:
the server terminal (4; 72; 102) generates a challenge (10);
the challenge (10) is sent from the server terminal (4; 72; 102) to the client terminal (2; 60; 100) over the network (58);
the client terminal (2; 60; 100) computes a first response (14) to the challenge (10), said computation comprising the application of a first function (12) on a first set comprising the secret (6; 106; 118) and the challenge (10);
the first response (14) is sent from the client terminal (2; 60; 100) to the server terminal (4; 72; 102) over the network (58);
the server terminal (4; 72; 102) computes a second response (16) to the challenge (10) by applying the first function (12) on the first set comprising the secret (6; 106; 118) and the challenge (10);
the server terminal (4; 72; 102) compares the first (14) and second (16) responses; and
the client terminal (2; 60; 100) is authenticated by the server terminal (4; 72; 102) if the first (14) and second (16) responses match,
characterized in that:
the step for generating the challenge (10) by the server terminal (4; 72; 102) comprises the following steps:
the server terminal (4; 72; 102) generates at least one random value (40; 116);
the server terminal (4; 72; 102) computes a first encrypted value (46; 120) by applying a second function (42) on a second set comprising the secret (6; 106; 118) and the random value (40, 116); and
the server terminal (4; 72; 102) concatenates the random value (40; 116) and the first encrypted value (46; 120) to form the challenge (10);
and in that the method comprises the following steps:
the client terminal (2; 60; 100) extracts the random value (40; 116) and the first encrypted value (46; 120) from the challenge (10);
the client terminal (2; 60; 100) computes a second encrypted value (48) by applying the second function (42) on the second set comprising the secret (6; 106; 118) and the random value (40; 116);
the client terminal (2; 60; 100) compares the first (46; 120) and second (48) encrypted values; and
the server terminal (4; 72; 102) is authenticated by the client terminal (2; 60; 100) if the first (46; 120) and second (48) encrypted values match.

2. The authentication method according to claim 1, characterized in that the step for computation by the client terminal (2; 60; 100) of a first response (14) to the challenge (10) comprises a step in which the client terminal (2; 60; 100) concatenates the challenge (10) and the result of the application of the first function (12) on the first set comprising the secret (6; 106; 118) and the challenge (10).

3. The authentication method according to claim 1, characterized in that the first (12) and second (42) functions are chosen in a group of functions comprising:
a key derivation function KDF;
a pseudo-random function PRF;
an MD5 hash function;
a SHA hash function;
an authentication code procedure MAC;
an authentication code procedure HMAC;
a symmetric encryption algorithm of the RC4 or DES or 3DES or AES type; and
an authentication algorithm A3.

4. The authentication method according to claim 1, characterized in that the first and second sets also comprise a plurality of known parameters (44) of the client and server terminals.

5. The authentication method according to claim 4, characterized in that the step for generation of the challenge (10) by the server terminal (4; 72; 102) comprises a step in which said server terminal (4; 72; 102) concatenates the random value (40; 116), the first encrypted value (46; 120) and the plurality of parameters (44).

6. The authentication method according to claim 4, characterized in that the step for computation by the client terminal (2; 60; 100) of a first response (14) to the challenge (10) comprises a step in which the client terminal (2; 60; 100) concatenates the challenge (10), the result of the application of the first function (12) on the first set comprising the secret (6; 106; 118) and the challenge (10) and the plurality of parameters (44).

7. The authentication method according to claim 1, characterized in that the data network is an Internet network (58) using a RADIUS infrastructure.

8. The authentication method according to claim 7, characterized in that the information exchanged between the client (60) and server (72) terminals is encapsulated in EAP packets.

9. The authentication method according to claim 8, characterized in that the EAP packets are exchanged between the client terminal (60) and the server terminal (72) via an access point.

10. The authentication method according to claim 9, characterized in that the access point is a network administration server NAS (66).

11. The authentication method according to claim 1, characterized in that the data transfer network is a GSM network.

12. The authentication method according to claim 11, characterized in that the client terminal (100) is a SIM card and the server terminal (102) comprises a home location register HLR and an authentication center AuC.

13. An authentication system comprising a client terminal (2; 60; 100) and a server terminal (4; 72; 102) connected to a data transmission network (58), said terminals sharing a secret (6; 106; 118) and said system comprising:
means for generation of a challenge (10) by the sever terminal (4; 72; 102);
means for sending the challenge (10) from the server terminal (4; 72; 102) to the client terminal (2; 60; 100) over the network (58);
means for computation by the client terminal (2; 60; 100) of a first response (14) to the challenge (10), said computing means comprising means for applying a first function (12) on a first set comprising the secret (6; 106; 118) and the challenge (10);
means for sending the first response (14) from the client terminal (2; 60; 100) to the server terminal (4; 72; 102) over the network (58);
means for computation by the server terminal (4; 72; 102) of a second response (16) to the challenge (10) comprising means for applying the first function (12) on the first set comprising the secret (6; 106; 118) and the challenge (10);
means for comparison by the server terminal (4; 72; 102) of the first (14) and second (16) responses; and
means for authentication of the client terminal (2; 60; 100) by the server terminal (4; 72; 102) if the first (14) and second (16) responses match,
characterized in that:
the means for generation of the challenge (10) by the server terminal (4; 72; 102) comprises:
means for generation by the server terminal (4; 72; 102) of at least one random value (40; 116);
means for computation by the server terminal (4; 72; 102) of a first encrypted value (46; 120) comprising means for applying a second function (42) on a second set comprising the secret (6; 106; 118) and the random value (40; 116); and
means for concatenation by the server terminal (4; 72; 102) of the random value (40; 116) and of the first encrypted value (46; 120) to form the challenge (10);
and in that the system comprises:
means for extraction by the client terminal (2;60;100) of the random value (40; 116) and of the first encrypted value (46; 120) from the challenge (10);
means for computation by the client terminal (2;60;100) of a second encrypted value (48) comprising means for applying the second function (42) on the second set comprising the secret (6; 106; 118) and the random value (40; 116);
means for comparison by the client terminal (2;60;100) of the first (46; 120) and second (48) encrypted values; and
means for authentication of the server terminal (4; 72; 102) by the client terminal (2;60;100) if the first (46; 120) and second (48) encrypted values match.

14. A server terminal (4; 72; 102) connected to a data network (58), said server terminal (4; 72; 102) sharing a secret (6; 106; 118) with a client terminal (2; 60; 100) connected to said network (58), and comprising:
means for generating a challenge (10);
means for sending the challenge (10) to the client terminal (2; 60; 100) over the network (58);
means for receiving a first response (14) to the challenge (10) from the client terminal (2; 60; 100);
means for computing a second response (16) to the challenge (10) comprising means for applying a first function (12) on a first set comprising the secret (6; 106; 118) and the challenge (10);
means for comparing the first (14) and second (16) responses; and
means for authenticating the client terminal (2; 60; 100) if the first (14) and second (16) responses match;
characterized in that:
the means for generating the challenge (10) comprises:
means for generating at least one random value (40; 116);
means for computing a first encrypted value (46; 120) comprising means for applying a second function (42) on a second set comprising the secret (6; 106; 118) and the random value (40; 116); and
means for concatenating the random value (40; 116) and the first encrypted value (46; 120) to form the challenge (10).

15. A client terminal (2; 60; 100) connected to a data transmission network (58), said client terminal (2; 60; 100) sharing a secret (6; 106; 118) with a server terminal (4; 72; 102) connected to said network (58) and comprising:
means for receiving a challenge (10) from the server terminal (4; 72; 102);
means for computing a first response (14) to the challenge (10), said computing means comprising means for applying a first function (12) on a first set comprising the secret (6; 106; 118) and the challenge (10);
means for sending the first response (14) to the server terminal (4; 72; 102) via the network (58),
characterized in that it comprises:
means for extracting a random value (40; 116) and a first encrypted value (46; 120) from the challenge (10);
means for computing a second encrypted value (48) comprising means for applying a second function (42) on a second set comprising the secret (6; 106; 118) and the random value (40; 116);
means for comparing the first (46; 120) and second (48) encrypted values; and
means for authenticating the server terminal (4; 72; 102) if the first (46; 120) and second (48) encrypted values match.

16. A computer program comprising code instructions, which, when the program is executed on a server terminal (4; 72; 102), allow the implementation of the steps of the authentication method consisting of:
generating at least one random value (40; 116);
computing a first encrypted value (46; 120) by applying a second function (42) on a second set comprising a secret (6; 106; 118) shared with a client terminal (2; 60; 100) and the random value (40; 116);
concatenating the random value (40; 116) and the first encrypted value (46; 120) to form a challenge (10);
sending the challenge (10) to the client terminal (2; 60; 100);
receiving a first response (14) to the challenge (10) from the client terminal (2; 60; 100);
computing a second response (16) to the challenge (10) by applying a first function (12) on a first set comprising a secret (6; 106; 118) shared with the client terminal (2; 60; 100) and the challenge (10);
comparing the first (14) and second (16) responses;
authenticating the client terminal (2; 60; 100) if the first (14) and second (16) responses match.

17. A computer program comprising code instructions, which, when the program is executed on a client terminal (2; 60; 100), make it possible to carry out the steps of the authentication method consisting of:
receiving a challenge (10) from a server terminal (4; 72; 102);
extracting a random value (40; 116) and a first encrypted value (46; 120) from the challenge (10);
computing a second encrypted value (48) by applying a second function (42) on a second set comprising a secret (6; 106; 118) shared with the server terminal (4; 72; 102) and the random value (40; 116);
comparing the first (46; 120) and second (48) encrypted values;
authenticating the server terminal (4; 72; 102) if the first (46; 120) and second (48) encrypted values match;
computing a first response to the challenge (10) by applying a first function (12) on a first set comprising the secret (6; 106; 118) and the challenge (10); and
sending the first response to the server terminal (4; 72; 102).

18. The authentication method according to claim 2, characterized in that the first (12) and second (42) functions are chosen in a group of functions comprising:
a key derivation function KDF;
a pseudo-random function PRF;
an MD5 hash function;
a SHA hash function;
an authentication code procedure MAC;
an authentication code procedure HMAC;
a symmetric encryption algorithm of the RC4 or DES or 3DES or AES type; and
an authentication algorithm A3.

19. The authentication method according to claim 5, characterized in that the step for computation by the client terminal (2; 60; 100) of a first response (14) to the challenge (10) comprises a step in which the client terminal (2; 60; 100) concatenates the challenge (10), the result of the application of the first function (12) on the first set comprising the secret (6; 106; 118) and the challenge (10) and the plurality of parameters (44).
